(19) United States
(12) Patent Application Publication
(10) Pub. No.: US 2003/0030854 A1
(43) Pub. Date: Feb. 13, 2003

(54) Focusing apparatus of an automatic document feeder

(76) Inventors: Yin-Chun Huang, Hsinchu (TW); Chih-Wen Huang, Hsinchu (TW)

Correspondence Address: Raymond Sun, 12420 Woodhall Way, Tustin, CA, 92782, US

(21) Appl. No.: 09/927,834

(22) Filed: Aug. 10, 2001

(51) Int. Cl. H04N 1/04

(52) U.S. Cl. 358/498

(57) ABSTRACT

A focusing apparatus of an automatic document feeder, having the automatic document feeder has a scanning zone for an optical chassis to retrieve an image of a document. The focusing apparatus of automatic document feeder comprises at least one focusing chart, which is disposed at a location corresponding to the scanning zone. The focusing chart is comprised of a plurality of focus detecting elements and capable of automatic focusing by the optical chassis.

### FIELD OF THE INVENTION

The present invention relates to a scanning apparatus carrying with automatic document feeder, especially to a kind of scanning apparatus with automatic adjustment of focusing that is made by the clearness of focusing chart arranged at the automatic document feeder and measured by the optical chassis.

### BACKGROUND OF THE INVENTION

Scanner is a kind of computer periphery of prevalence, of which main function is to retrieve a document image and convert the retrieved image into digital signals that are input into computer for proceeding image treatment.

Please refer to FIG. 1, which shows a structure illustration for a prior flatbed scanner. The prior flatbed scanner comprises a hollow machine shell 60, of which interior includes a light source 10 and an optical chassis 30, and a scanned document 20 placed on the upper surface of the machine shell 60.

Wherein the optical chassis 30 comprises a hollow shell body 34, having the light source 10 is positioned at an appropriate position on the upper side surface of the shell body 34, plural number of reflection mirrors 31, a lens set 32, and a charge-coupled device 33. When the light source 10 emits light onto the scanned document 20, the reflected light enters into the shell body 34 of the optical chassis 30. After the light is reflected and direction-changed for increasing its optical length through plural number of reflection mirrors 31, the light is focused by the lens set 32 and imaged on the charge-coupled device 33 that converts the scanned image data into electronic signals.

Please refer to FIG. 2, which shows an illustration for a feeding-typed scanning mechanism of automatic document feeder arranged in a prior flatbed scanner. When the flatbed scanner proceeds feeding-typed scanning, an automatic document feeder 40 is carried on the flatbed scanner. After the optical chassis 30 is moved to the scanning zone of the automatic document feeder 40, the optical chassis 30 is fixed. The automatic document feeder 40 is arranged with a scanning zone 47 for providing the optical chassis 30 to proceed the image retrieving of the scanned document 20. After an image is generated from the light source 10 and reflected through the scanned document 20, the reflected light enters into the shell body 34 of the optical chassis 30. After the light is reflected and direction-changed for increasing its optical length to an appropriate length through plural number of reflection mirrors 31, the light is focused by the lens set 32 and imaged onto the charge-coupled device 33. The charge-coupled device 33 then converts the scanned image data into electronic signals.

Since the flatbed scanner is matched with the automatic document feeder 40, so a focusing clearance 50 may be existed between the document 20 and flatbed scanner. Therefore, after the automatic document feeder is arranged, the image clearness shown on the charge-coupled device 33 is inferior to that of flatbed scanning.

In addition, since the automatic document feeder 40 is not carried and applied on the same kind of flatbed scanner, so the focusing clearance 50 will generate different lengths of focusing clearance 50 because of being connected and applied with different kind of flatbed scanner. Therefore, according to this, in order to use more convenient automatic feeding-typed scanning, it is then reluctant to accept the clearness showing poor images. So, for the enterprises engaging in the relative business of scanners, they all devote their efforts on researching perfect solution for this sort of problem for promoting the competition abilities of this industry.

### SUMMARY OF THE INVENTION

The object of the present invention is to provide a focusing apparatus of an automatic document feeder, wherein a further clear image retrieving is made on a document provided by the automatic document feeder to reach optimal image clearness formed on the charge-coupled device.

To reach above-mentioned object, a focusing apparatus of an automatic document feeder of the present invention, having a scanning zone for an optical chassis to retrieve an image of a document. The focusing apparatus of automatic document feeder comprises at least one focusing chart. The focusing chart is disposed at a location corresponding to the scanning zone. The focusing chart is comprised of a plurality of focus detecting elements and capable of automatic focusing by the optical chassis.

For your esteemed reviewing committee to further understand and recognize the objects, functions, and characteristics of the present invention, a detailed description matched with a plurality of drawings are presented as following.

### BRIEF DESCRIPTION OF THE DRAWINGS

FIG. 1 is a structure illustration for a prior flatbed scanner.

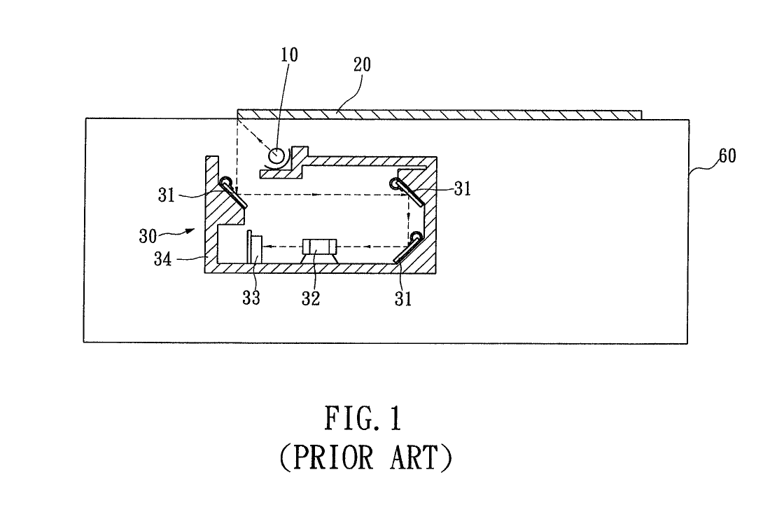

FIG. 2 is an illustration for a feeding-typed scanning mechanism of automatic document feeder carried on a prior flatbed scanner.

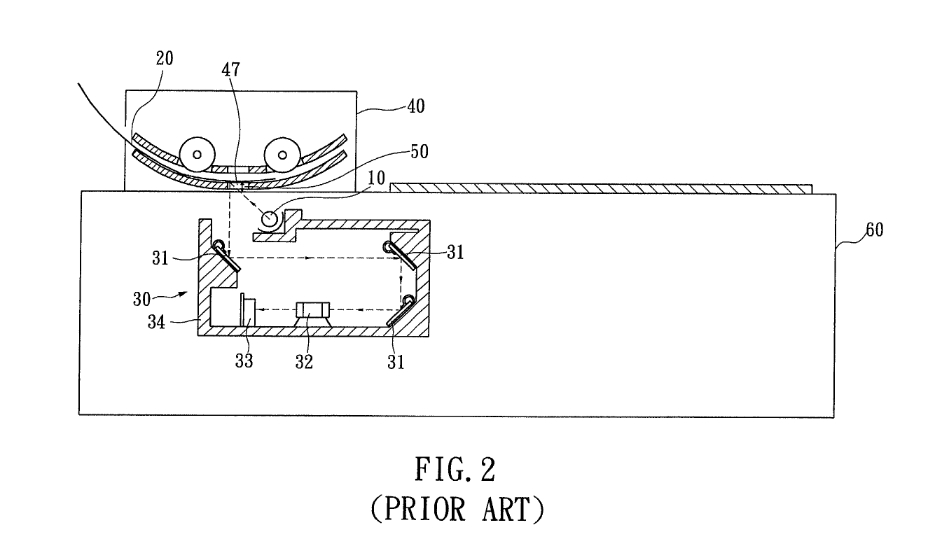

FIG. 3A is an illustration for a preferable embodiment of a pre-focusing light path for an automatic document feeder carried by the flatbed scanner of the present invention.

FIG. 3B is an illustration for a preferable embodiment of an after-focusing light path for an automatic document feeder carried by the flatbed scanner of the present invention.

FIG. 4 is a structure illustration for a preferable embodiment for the focusing chart of the present invention.

FIG. 5 is a cross-sectional structure illustration for a preferable embodiment for the automatic document feeder of the present invention.

FIG. 6A is a three-dimensional structure illustration for the first preferable embodiment of the focusing apparatus for the automatic document feeder of the present invention.

FIG. 6B is a three-dimensional structure illustration for the second preferable embodiment of the focusing apparatus for the automatic document feeder of the present invention.

FIG. 6C is a three-dimensional structure illustration for the third preferable embodiment of the focusing apparatus for the automatic document feeder of the present invention.

### DETAILED DESCRIPTION OF THE PREFERRED EMBODIMENTS

The characteristic of the present invention is that the automatic document feeder comprises at least one focusing chart to make the optical chassis measure its clearness for making appropriate adjustment to reach optimally clear image formed on the charge-coupled device.

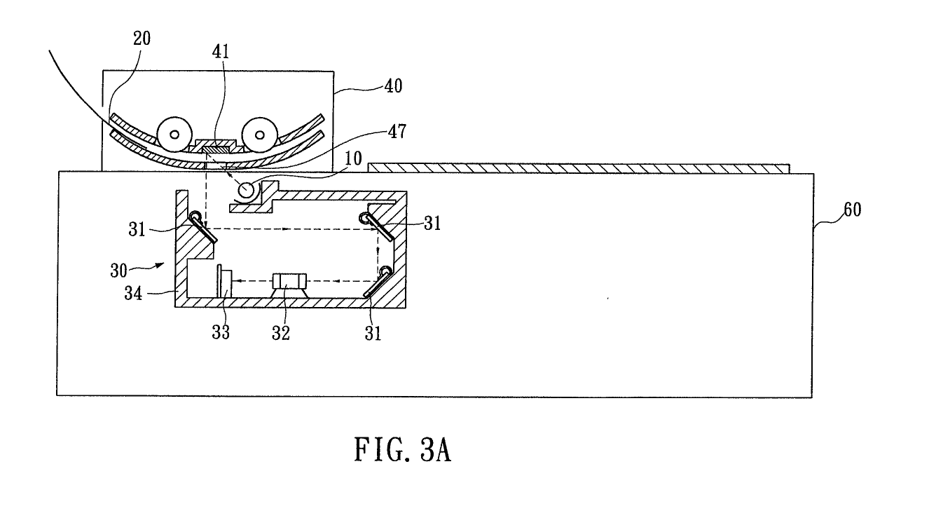

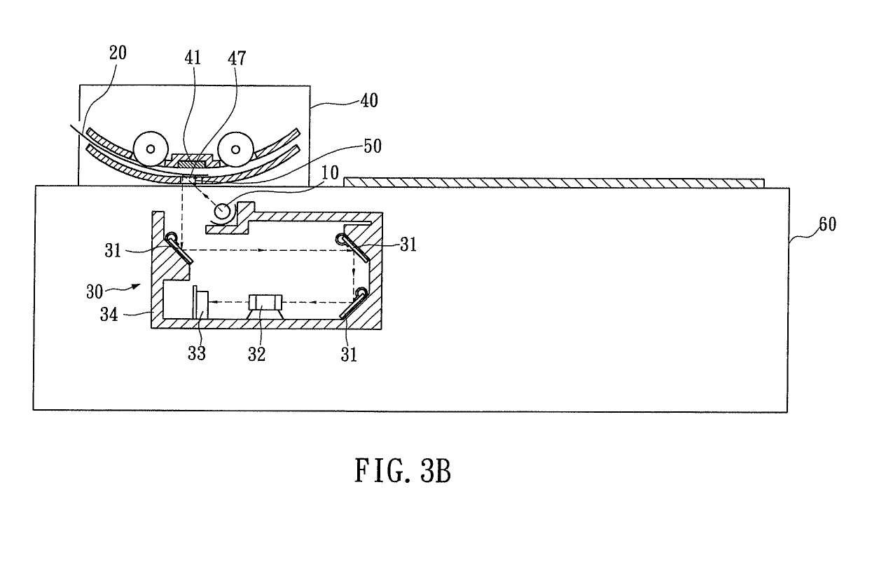

Please refer to FIG. 3A and FIG. 3B, which are illustrations for a focusing preferable embodiment for an automatic document feeder carried by the flatbed scanner of the present invention. Wherein, the flatbed scanner includes a hollow machine shell 60, of which interior includes a light source 10 and an optical chassis 30, and a scanned document 20 placed on the upper surface of the machine shell 60.

Wherein, the optical chassis 30 comprises a hollow shell body 34, having the light source 10 is positioned at an appropriate position on the upper side surface of the shell body 34, plural number of reflection mirrors 31, a lens set 32, and a charge-coupled device 33. When the light source 10 emits light onto the scanned document 20, the reflected light enters into the shell body 34 of the optical chassis 30. After the light is reflected and direction-changed for increasing its optical length through plural number of reflection mirrors 31, the light is focused by the lens set 32 and imaged on the charge-coupled device 33 that converts the scanned image data into electronic signals.

When the flatbed scanner proceeds feeding-typed scanning, an automatic document feeder 40 is carried on the flatbed scanner. After the optical chassis 30 is moved to the scanning zone of the automatic document feeder 40, the optical chassis 30 is fixed. The automatic document feeder 40 is arranged with a scanning zone 47 for providing the optical chassis 30 to proceed the image retrieving of the scanned document 20. After an image is generated from the light source 10 and reflected through the scanned document 20, the reflected light enters into the shell body 34 of the image-retrieving apparatus 30. After the light is reflected and direction-changed for increasing its optical length to an appropriate length through plural number of reflection mirrors 31, the light is focused by the lens set 32 and imaged onto the charge-coupled device 33. The charge-coupled device 33 then converts the scanned image data into electronic signals.

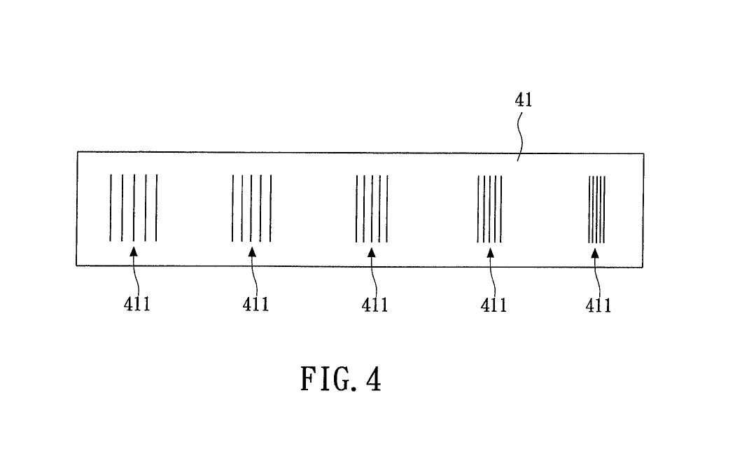

Preferably in the present invention, the automatic document feeder 40 further comprises at least one focusing chart. The focusing chart is arranged at correspondingly appropriate position in the scanning zone 47. FIG. 4 shows a structure illustration of a preferable embodiment of the focusing chart of the present invention. The focusing chart 41 is comprised of a plurality of focus detecting elements 411 of black-and-white stripe patterns of different densities. The plurality of focus detecting elements 411 may make automatic focusing by the clearness difference measured by the optical chassis 30.

Wherein, before the automatic document feeder 40 automatically feeds the scanned document 20 into a scanner. In the optical chassis 30, the image is generated by the light emitted from the light source 10 and reflected through the focusing chart 41. After being reflected by a plurality of reflection mirrors, and through being focused onto the charge-coupled device 33 by the lens set 32, the image may be converted into digital signals manageable by the computer. The optical chassis 30 measures the clearness difference of the focus detecting elements 411. By applying the a plurality of reflection mirrors 31 arranged with at least one reflection mirror capable of rotation (not shown in the drawings) and lens set 32 to adjust the distance of its focused images or computer software to take care adjustment, the image's clearness formed on the charge-coupled device 33 is changed. After the optimal image's clearness formed on the charge-coupled device is completed, in the optical chassis 30 the image is generated by the light emitted from the light source 10 and reflected through the document 20. After being reflected by a plurality of reflection mirrors 31, and again through the lens set 32, the image is focused onto the charge-coupled device 33 for converting into digital signals manageable by the computer.

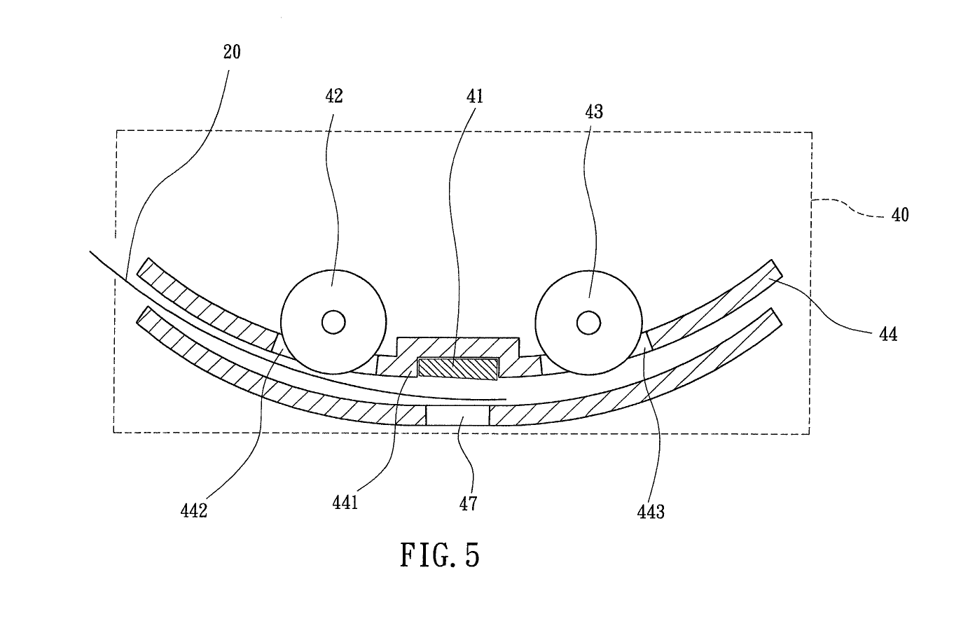

Please refer to FIG. 5, which is a cross-sectional structure illustration for a preferable embodiment of the automatic document feeder of the present invention. Wherein the automatic document feeder 40 is further arranged with a guiding board 44, which is kept an appropriate height from the scanning zone 47, and the appropriate height may provide a passage for the document 20. The guiding board 44 is at least arranged with a groove 441 for providing a connection with the focusing chart 41, a first open groove 442 that is arranged at an appropriate position away from the groove 441 for providing a placing-into roller 42 to make the document 20 placed into the automatic document feeder 40, and a second open groove 443 that is arranged correspondingly to the first open groove 442 for providing a releasing roller 43 to make the document 20 released from the automatic document feeder.

The groove 441 is connected in the proximity of one side end of the open groove 442 and appropriately projected out from the focusing chart 41. This design may prevent the document 20 from being blocked and being unable to enter smoothly. Another side end, after being connected, is appropriately placed under the focusing chart 41. This design may make the document be able to leave smoothly and without being blocked.

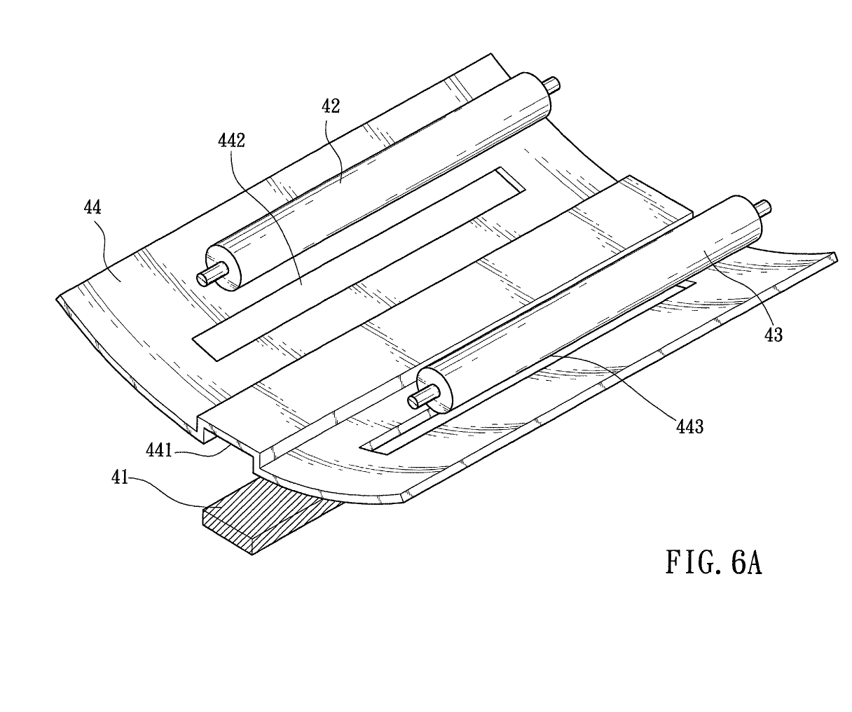

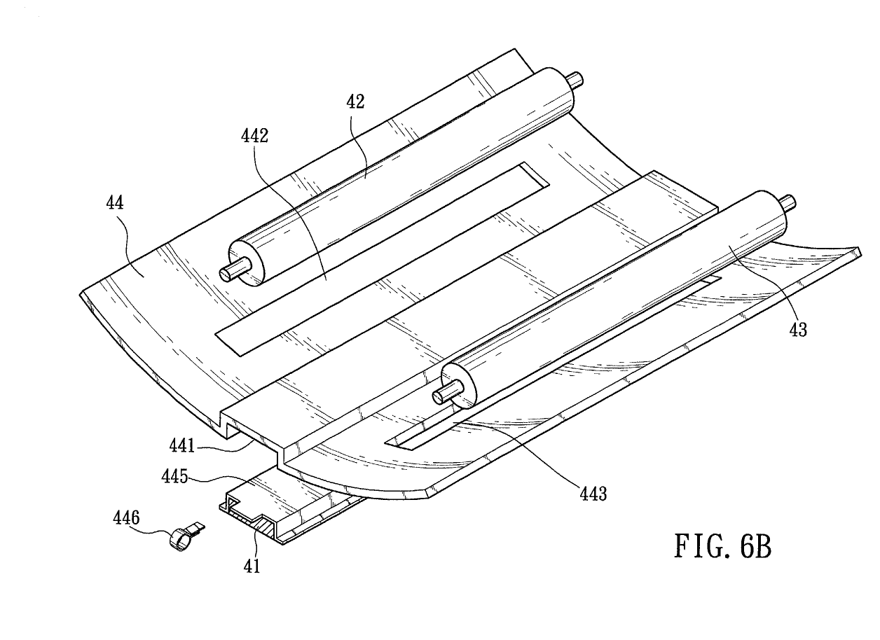

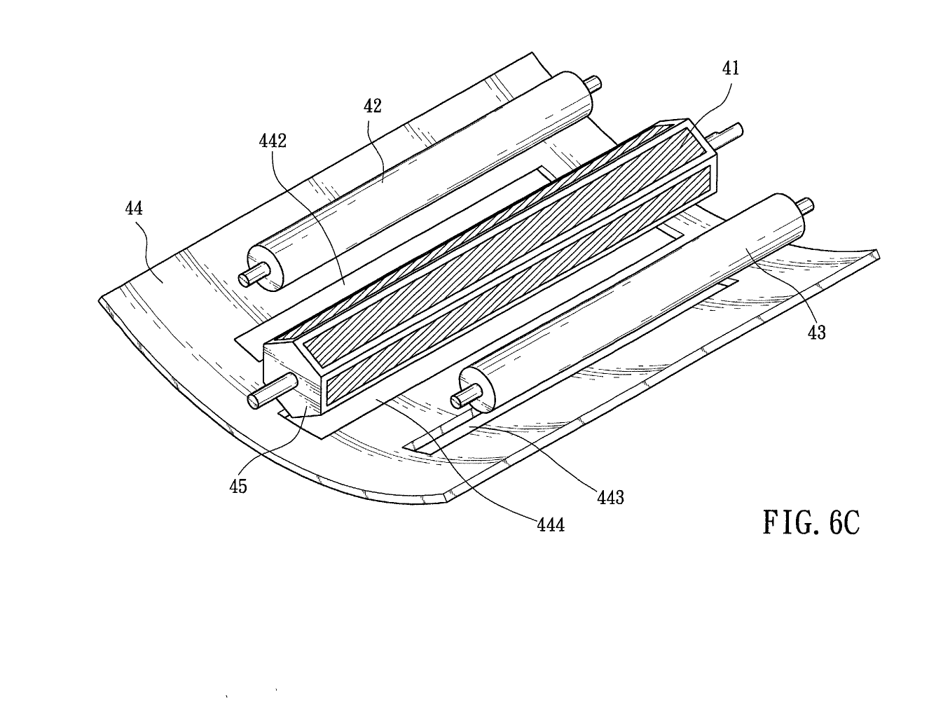

Please refer to FIG. 6A through FIG. 6C, which show the three-dimensional structure illustrations for preferable embodiments for the focusing apparatus of the automatic document feeder of the present invention. The focusing chart 41 may be connected and secured with the groove 441 by the manner of direct pasting.

Of course, it may also that the focusing chart 41 is arranged on a focusing-connection-seat 445. The focusing-connection-seat 445 is connected to the groove 441 with at least one fastener 446. The fastener 446 is provided for the focusing-connection-seat 445 to be placed in and secured with the groove 441 or be pulled out and inter-released from the groove 441. During the situation required for preferable clearness, the focusing-connection-seat 445 may be inter-changed with another focusing-connection-seat 445 for being connected with the focusing chart 41 with more dense density of focus detecting zone 411 to reach clearness of better adjustment. This design may provide the function for inter-changing the focusing charts 41.

In another preferable embodiment of the present invention, wherein the guiding board 44 is at least arranged with: a penetrating groove 444, which is arranged correspondingly to the scanning zone 47, a first open groove 442, which is arranged at an appropriate position away from the penetrating groove 444 for providing a placing-into roller 42 to make the document 20 enter the automatic document feeder 40, and a second open groove 443, which is arranged correspondingly to the first open groove 442 for providing a releasing roller 43 to make the document 20 released from the automatic document feeder 40. Wherein a rotating wheel 45 is further arranged on the upper portion of the guiding board 44. The rotating wheel 45 may be connected with a plurality of focusing charts 41 of different densities and arranged annularly. One focusing chart 41 may be rotated and secured by a gear set in corresponding to the penetrating groove 444. When a preferable clearness is required, a focusing chart 41 with focus detecting zone 411 of denser density is selected in corresponding to the penetrating groove 444.

What is claimed is:

1. A focusing apparatus of an automatic document feeder, having a scanning zone for an optical chassis to retrieve an image of a document, comprising:
at least one focusing chart, disposed at a location corresponding to the scanning zone, comprised of a plurality of focus detecting elements and capable of automatic focusing focus detecting by the optical chassis.

2. The focusing apparatus of an automatic document feeder of claim 1, wherein the plurality of focus detecting elements is black-and-white stripe patterns of different densities.

3. The focusing apparatus of an automatic document feeder of claim 1, wherein in the optical chassis, the image is generated by the light emitted from the light source and reflected through the document, after being reflected by a plurality of reflection mirrors, and through the lens set, the image is focused onto the charge-coupled device for converting into digital signals manageable by the computer.

4. The focusing apparatus of an automatic document feeder of claim 3, wherein the automatic focusing is made by arranging at least one reflection mirror capable of rotation to rotate and adjust for changing the image's clearness formed on the charge-coupled device.

5. The focusing apparatus of an automatic document feeder of claim 3, wherein the automatic focusing is made by lens set to adjust the distance of its focused image for changing the image's clearness formed on the charge-coupled device.

6. The focusing apparatus of an automatic document feeder of claim 3, wherein the automatic focusing is made by treatment and adjustment of computer for changing the image's clearness formed on the charge-coupled device.

7. The focusing apparatus of an automatic document feeder of claim 1, wherein the automatic document feeder is further arranged with a guiding board, which is kept an appropriate height from the scanning zone, and the appropriate height provide a passage for the document.

8. The focusing apparatus of an automatic document feeder of claim 7, wherein the guiding board comprising:
a groove for providing a connection with the focusing chart;
a first open groove arranged at an appropriate position away from the groove for providing a placing-into roller to make the document placed into the automatic document feeder; and
a second open groove arranged correspondingly to the first open groove for providing a releasing roller to make the document released from the automatic document feeder.

9. The focusing apparatus of an automatic document feeder of claim 8, wherein the groove is connected in the proximity of one side end of the open a groove and appropriately projected out from the focusing chart, and another side end, after being connected, is appropriately placed under the focusing chart.

10. The focusing apparatus of an automatic document feeder of claim 8, wherein the focusing chart is connected with the groove by the manner of direct pasting.

11. The focusing apparatus of an automatic document feeder of claim 8, wherein the focusing chart is arranged on a focusing-connection-seat that is connected to the groove with at least one fastener.

12. The focusing apparatus of an automatic document feeder of claim 7, wherein the guiding board comprising:
a penetrating groove, which is arranged correspondingly to the scanning zone;
a first open groove, having an appropriate position away from the penetrating groove for providing a placing-into roller to make the document enter the automatic document feeder; and
a second open groove, which is arranged correspondingly to the first open groove for providing a releasing roller to make the document released from the automatic document feeder.

13. The focusing apparatus of an automatic document feeder of claim 12, wherein a rotating wheel is further arranged on the upper portion of the guiding board, and the rotating wheel can be connected with a plurality of focusing charts of different densities and arranged annularly to provide rotation and fixation for a focusing chart in corresponding to the penetrating groove.

14. The focusing apparatus of an automatic document feeder of claim 13, wherein the rotating wheel is rotated and secured by a gear set.
